(19) United States
(12) Patent Application Publication
(10) Pub. No.: US 2003/0042431 A1
(43) Pub. Date: Mar. 6, 2003

(54) Fuse and anti-fuse concept using a focused ion beam writing technique

(76) Inventors: Lawrence A. Clevenger, LaGrangeville, NY (US); Louis Lu-Chen Hsu, Fishkill, NY (US); Joseph F. Shepard JR., Fishkill, NY (US); Keith Kwong-Hon Wong, Wappingers Falls, NY (US); Li-Kong Wang, Montvale, NJ (US)

Correspondence Address: Steven Fischman, Scully, Scott, Murphy & Presser, 400 Garden City Plaza, Garden City, NY, 11530, US

(21) Appl. No.: 09/941,287

(22) Filed: Aug. 28, 2001

(51) Int. Cl. G21K 5/10

(52) U.S. Cl. 250/492.21

(57) ABSTRACT

A high-resolution focused ion beam programming technique wherein fuse-like and anti-fuse-like elements are provided for on-chip tight-area circuit programming applications. The focused ion beam programming can be used in a very high density circuit area and thus increase the design flexibility. Compared to laser programming techniques, the yield of focused ion beam programming can be much higher due to its high-resolution, localized heating and non-destructive nature.

### BACKGROUND OF THE INVENTION

1. Field of the Invention

The present invention relates generally to a fuse and anti-fuse concept using a focused ion beam writing technique, and more particularly pertains to a fuse and anti-fuse concept using a focused ion beam writing technique wherein fuse-like or anti-fuse-like elements are provided for on-chip tight-area circuit programming applications. The focused ion beam programming can be used in a very high density circuit area and thus increase the circuit design flexibility. Compared to laser programming techniques, the yield of focused ion beam programming can be much higher due to its high-resolution, localized heating and non-destructive nature.

2. Discussion of the Prior Art

The semiconductor industry has used focused ion beam writing techniques for many applications, including changing the conductivity of insulating films, depositing dielectric or conductive materials, and trimming of circuits.

As reported by M. F. Edinger et al. [Focused Ion Beam Writing Of Electrical Connections Into Platinum Oxide Film, Appl. Phys. Let. (USA) Vol. 76, No. 23, Jun. 5, 2000, P3445-7], a focused Ga+ion beam system has been demonstrated to change the sheet resistance of an insulating platinum oxide film from 4E9 ohm/square into a conducting film with a sheet resistance of 5E2 ohm/square. The large decrease in resistance is caused by an oxygen loss caused by the focused ion beam irradiation. It has been reported that the resolution of the focused ion beam patterning is more than one order of magnitude higher than the resolution of patterning by a laser. In addition, the film quality after ion irradiation is more homogeneous than the film quality after laser irradiation.

The focused ion beam systems are very attractive and versatile tools to make precision modifications in the deep submicron range. For example, using a liquid metal ion source of Ga+ions, the ion beam can be focused down to 5nm, allowing chemical processes to be confined to nanometer dimensions. The same tool makes it feasible to deposit metals and insulators by sputtering processes, and also to conduct chemical assisted etching and doping in confined areas. The focused ion beam tools have also been used commonly for rapid and flexible chip modification [J. Melingailis, J. Vac Sci. Technol, B5, 469, (1987); T. Tao, W. Wilinkinson, J. Melingailis, J. Vac. Sci. Technol. B9, 162, (1991)].

In focused ion beam metal deposition processes, a stream of precursor gas is directed towards the area of interest where the focused ion beam is writing (the local area is in the mTorr pressure range while the chamber base pressure is in the low 10-7 Torr pressure range). Incident ions of Ga, Cs 02, Ar, N2 etc. break up the gas molecules that are adsorbed onto the surface leading to a metallic deposit. Commonly used metal precursor gases are organometallic or metal halides. Depositions of Au, W, Ta, Al, Pt have been demonstrated. To lower the sheet resistance of the deposits, a post deposition anneal can be carried out.

Focused ion beam deposition of silicon dioxide from tetramethoxysilane and oxygen using a Si ion source has also been reported. Typical beam acceleration voltages and currents are 5 to 50 keV and 0.1 to 2 nA respectively.

Focused ion beam assisted deposition has also been used for circuit modification in integrated circuits [Wang Tai-Ho, U.S. Pat. No. 5,741,727, Circuit Modification And Repair Using A Low Resistance Conducting Metal Bridge And A Focused Ion Beam]. Focused ion beam milling can also be performed with a pure positively charged Ga ion beam, which is usually generated by applying a high electric field between the liquid-metal ion source (Ga) and an ion extractor. The beam energy is typically around 30 to 50 keV and the beam current is typically from 1 to several tens of nA. The beam size resolution can be down to a few nanometers. The beam is programmed to raster across the wafer surface, which is maintained under a high vacuum (around 10-7 mbar).

Nanometer-size GaN/AIGaN device structures fabricated by focused ion beams have also been reported [Kuball, M. Benyoucef, M. Morrissey, F. H. Foxon, “Focused Ion Beam Etching Of Nanometer-Size GaN/AIGaN Device Structures And Their Optical Characterization By Micro-Photoluminescence/Raman Mapping”, Materials Research Society Symposium-Proceedings, V595, 2000, Materials Research Society, Warrendale, Pa., USA, p W12.3.1-W12.3.6].

To enhance the etching rate, and to minimize the Ga stain, additional gases can be flowed to the area of interest. For example, xenon difluoride can be used to enhance the etching of silicon dioxide, halogen gases have been used to enhance the etching of aluminum, and water vapor has been used to assist in the removal of carbon-based materials.

Wang U.S. Pat. No. 5,741,727 discloses the use of a low resistance conducting metal bridge to form long electrodes having a low resistance for the modification and repair of microcircuit wiring patterns. The conducting metal bridge is formed using a patterned transparent mask and sputtering or evaporation of a conductor. The connections from the conducting metal bridge to the wiring pattern are formed using focused ion beam assisted chemical vapor deposition which have a low resistance because the length of these connections is small.

However none of the techniques mentioned above have ever been implemented in semiconductor fuse and anti-fuse applications, or used to conduct massive programmability in an automatic manner.

### SUMMARY OF THE INVENTION

Accordingly, it is a primary object of the present invention to provide a fuse and anti-fuse concept using a focused ion beam writing technique which provides compact programmable elements that can be programmed using a focused ion beam technique.

A further object of the subject invention is the provision of a fuse and anti-fuse alike element which can be programmed by a high-resolution conductor etching or deposition technique provided by a focused beam tool, and to provide a programmable fuse and anti-fuse like element that can be programmed and reprogrammed repeatedly more than once.

### BRIEF DESCRIPTION OF THE DRAWINGS

The foregoing objects and advantages of the present invention for a fuse and anti-fuse concept using a focused ion beam writing technique may be more readily understood by one skilled in the art with reference being had to the following detailed description of several embodiments thereof, taken in conjunction with the accompanying drawings wherein like elements are designated by identical reference numerals throughout the several views, and in which:

FIG. 1(a) illustrates a latch circuit which incorporates therein a first embodiment of the present invention wherein a fuse-like element of any type of conductor or metal can be programmed by a selective open circuit by using a focused ion beam.

FIG. 1(b) illustrates waveforms of operation of the circuit of FIG. 1(a), wherein the unprogrammed mode of operation is shown in dotted lines in FIG. 1(b)(3) and the programmed mode of operation is shown in solid lines in FIG. 1(b)(3).

FIG. 2(a) illustrates a latch circuit which incorporates therein a second embodiment of the present invention having an anti-fuse-like element which can be programmed by a selective short circuit by using a focused ion beam.

FIG. 2(b) illustrates waveforms of operation of the circuit of FIG. 2(a), wherein the unprogrammed mode of operation is shown in solid lines in FIG. 1(b)(3) and the programmed mode of operation is shown in dotted lines in FIG. 1 (b)(3).

FIG. 3 illustrates a third embodiment of the present invention having a plurality of anti-fuse elements provided for a plurality of conductive wires or metal wires.

FIG. 4 illustrates a fourth embodiment of the present invention wherein a focused ion beam etching process is used to cut a conductor or metal at a specific location for programming to open circuit one or more of a plurality of wires.

FIG. 5 illustrates a fifth embodiment of the subject invention which uses focused ion beam metal deposition to selectively deposit a conductor or metal at a specific opening location of a wire for programming, such that after the local metal deposition, one or more of a plurality of wires is short-circuited.

FIG. 6 shows a sixth embodiment of the present invention wherein an array of fuse-like or anti-fuse like elements is provided on a plurality of conductive pieces, and a focused ion beam provides a selective connection of conductive pieces for programming.

### DETAILED DESCRIPTION OF THE DRAWINGS

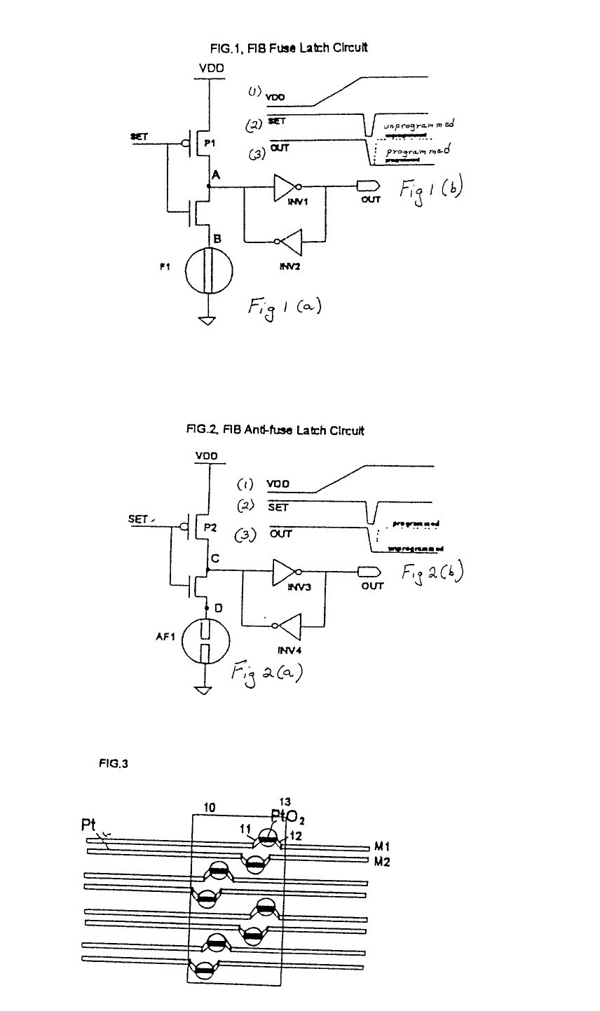

FIG. 1(a) illustrates a latch circuit which incorporates therein a first embodiment of the present invention wherein a fuse-like element of any type of conductor such as a metal conductor can be programmed by a selective open circuit by using a focused ion beam.

FIG. 1(b) illustrates waveforms of operation of the circuit of FIG. 1(a), wherein the unprogrammed mode of operation is shown in dotted lines in FIG. 1(b)(3) and the programmed mode of operation is shown in solid lines in FIG. 1(b)(3).

The focused ion beam local metal etching or milling technique has been demonstrated by Kuball et al. Before programming, the fuse-like element F1, e.g. doped polysilicon, conductive wiring, metal wiring, etc., shorts the internal node B to the ground. Therefore, as shown in the waveform diagrams of FIG. 1(b), after the chip is powered on and Vdd is established, a set signal sets the fuse latch by turning on the pull-up pMOS device PI with a short negative pulse. Since the fuse is not yet programmed, the voltage at node A returns back to ground and the output voltage is high, as shown by the dotted waveform of FIG. 1(b)(3). On the other hand, after the fuse is programmed and open-circuited by a focused ion beam, then the voltage at node A is maintained high and the output voltage is low, as shown by the solid waveform of Figure 1(b)(3).

One key advantage of using a focused ion beam fuse is that it can have a very fine or high patterning resolution. The focused ion beam fuse allows programmable circuits to be formed in very tight areas, such as in a pitch-limited layout area. The present invention makes it possible to form laser programmable circuits, and to drastically increase the programmability of semiconductor chips.

FIG. 2(a) illustrates a latch circuit which incorporates therein a second embodiment of the present invention having an anti-fuse-like element which can be programmed by a selective short circuit by using a focused ion beam.

FIG. 2(b) illustrates waveforms of operation of the circuit of FIG. 2(a), wherein the unprogrammed mode of operation is shown in solid lines in FIG. 1(b)(3) and the programmed mode of operation is shown in dotted lines in Figure 1(b)(3).

The anti-fuse-like element can be formed of any type of conductor or disconnected metal or a kind of metal oxide such as Pt02 as mentioned above so that it can be programmed and short-circuited by a focused ion beam. Wang Tai-Ho discloses and teaches a local metal deposition technique. The focused ion beam metal oxide local annealing has also been described by Edinger et al. Before programming, the anti-fuse-like element is opened as shown in FIG. 2(a), and AF1 disconnects the internal node D from the ground. Therefore, as shown by the solid waveform diagrams of FIG. 2(b)(3), after the chip is powered on and Vdd is established, a set signal sets the fuse latch by turning on the pull-up pMOS device P1 with a short negative pulse. Since the anti-fuse is unprogrammed, the voltage on node C is maintained high and the output voltage is low. On the other hand, after the anti-fuse is programmed by a focused ion beam, the node D will be connected to ground and thus the voltage at node C will be ground also, so that the output voltage will be high, as shown by the dotted waveform of FIG. 2(b)(3). One advantage to using a focused ion beam anti-fuse is that it can achieve a very fine or high patterning resolution.

FIG. 3 illustrates a third embodiment of the present invention having a latch circuit which incorporates therein anti-fuse elements 10 provided for a plurality of conductive wires or metal wires, e.g. M1 and M2. These wires can be, for example, platinum titanium with a shape structure as shown in FIG. 3. At least one portion of the metal wire is oxidized to form a metal oxide 13, e.g. Pt02. Since Pt02 has a high resistively, the conductivity of the wires is originally poor. After focused ion beam programming, which causes a significant loss of oxygen inside the Pt02, the sheet resistance of the Pt02 typically drops from 4E9 to 5E2 ohm/square, such that the programmed wire becomes conductive. One advantage of such programming is that the high-resolution focused ion beam irradiation process is very clean and no debris is created.

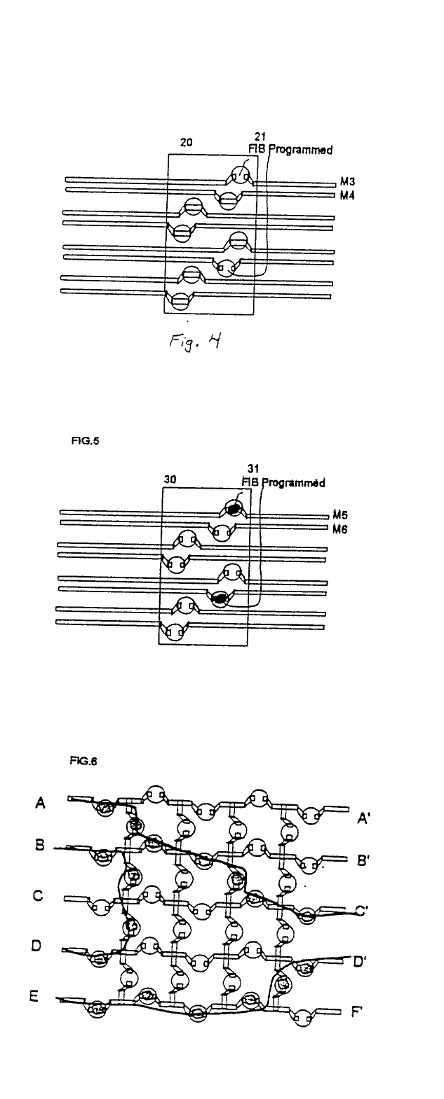

FIG. 4 illustrates a fourth embodiment of the present invention wherein a focused ion beam etching process is used to cut the conductor or metal at a specific location 21 for programming to open circuit the metal of one or more of a plurality of wires.

FIG. 5 illustrates a fifth embodiment of the subject invention which uses focused ion beam metal deposition to selectively deposit a conductor or metal at a specific opening location 31 of a wire, e.g. M5. After the local conductor or metal deposition, one or more of a plurality of wires is short circuited as shown in FIG. 5.

FIG. 6 shows a sixth embodiment of the present invention wherein an array of fuse-like or anti-fuse like elements is provided on a plurality of conductive of metal pieces. FIG. 6 specifically illustrates as anti-fuse embodiment wherein programming using a focused ion beam to provide a selective connection of conductive or metal pieces. For example, in FIG. 6, conductive connections between A-C’, B-D and E-D’ are formed. This technique is very useful to increase the capability of local logic programmability. This provides increased design flexibility, especially during a prototype development period.

While several embodiments and variations of the present invention for a fuse and anti-fuse concept using a focused ion beam writing technique are described in detail herein, it should be apparent that the disclosure and teachings of the present invention will suggest many alternative designs to those skilled in the art.

Having thus described our invention, what we claim as new and desire to secure by Letters Patent is:

1. A method of programming an electrical device by establishing conductive or nonconductive paths therein comprising:
providing at least one programmable element in a conductive path of the electrical device;
programming the at least one programmable element by using a focused ion beam writing technique to modify the conductivity of the at least one programmable element.

2. The method of claim 1, wherein the at least one programmable element comprises at least one fuse element which is selectively open-circuited by the focused ion beam.

3. The method of claim 1, wherein the at least one programmable element comprises at least one anti-fuse element which is selectively short-circuited by the focused ion beam.

4. The method of claim 1, wherein the at least one programmable element comprises a resistive element which is selectively changed in resistance by the focused ion beam.

5. The method of claim 1, wherein the focused ion beam is used to cut and open circuit a programmable conductor.

6. The method of claim 1; wherein the focused ion beam is used in a deposition process to selectively deposit a conductor on a programmable element.

7. The method of claim 1, wherein a plurality of programmable elements are provided in a plurality of conductive paths.

8. The method of claim 1, wherein an array of programmable elements are provided in an array of conductive paths.

9. The method of claim 1, wherein the at least one programmable element is a component of an electrical latch circuit, and the output of the latch circuit changes between a low state and a high state depending upon whether the programmable element is programmed or not.
